(19) United States
(12) Patent Application Publication
(10) Pub. No.: US 2024/0316512 A1
(43) Pub. Date: Sep. 26, 2024

(54) MEANS AND METHODS OF OPERATING DEVICES WITH MULTIPLE MAGNETS

(71) Applicant: Preomics Gmbh, Martinsried (DE)

(72) Inventors: Martin Kasemann, Monheim (DE); Nils A. Kulak, Munchen (DE)

(21) Appl. No.: 18/576,287

(22) PCT Filed: Jul. 15, 2022
(86) PCT No.: PCT/EP2022/069945

§ 371 Date: Jan. 3, 2024

(30) Foreign Application Priority Data
Jul. 16, 2021 (EP) 21186129.9

(51) Int. Cl. B01F 33/452; B01F 33/81; B01F 35/212; B01F 35/22

(52) U.S. Cl. CPC B01F 33/452; B01F 33/813; B01F 35/212; B01F 35/2209

(57) ABSTRACT

The present invention relates to a method of operating a device, said device comprising an array of vessels, one or more coils in sufficient proximity of at least two of said vessels such that an electric current flowing through said coil(s) exposes the interior of said vessels to a magnetic field, said at least two vessels each containing at least one first permanent magnet, and a power source connected to said coil(s), said method comprising: (a) delivering a fluctuating or oscillating electric current to said coil(s) to trigger movement of the first permanent magnets; and (b) intermittently applying a magnetic pulse sufficient to render first permanent magnets in nearby vessels not magnetically aligned with each other.

The present invention relates to a method of operating a device, said device comprising an array of vessels, one or more coils in sufficient proximity of at least two of said vessels such that an electric current flowing through said coil(s) exposes the interior of said vessels to a magnetic field, said at least two vessels each containing at least one first permanent magnet, and a power source connected to said coil(s), said method comprising: (a) delivering a fluctuating or oscillating electric current to said coil(s) to trigger movement of the first permanent magnets; and (b) intermittently applying a magnetic pulse sufficient to render first permanent magnets in nearby vessels not magnetically aligned with each other.

In this specification, a number of documents including patent applications and manufacturer's manuals are cited. The disclosure of these documents, while not considered relevant for the patentability of this invention, is herewith incorporated by reference in its entirety. More specifically, all referenced documents are incorporated by reference to the same extent as if each individual document was specifically and individually indicated to be incorporated by reference.

The use of moving magnets in vessels holding samples is widespread and includes processes of preparing biological and clinical samples for downstream analysis, e.g. by mass spectrometry. A magnet moving inside a vessel holding a sample may not only be a means of mixing, but, as described e.g. in applicant's earlier applications WO 2020/002577 and WO 2021/228971, of breaking up of biological cells and fragmenting of biomolecules.

When these and other processes are performed in a high-throughput manner, e.g. in the wells of microtiter plates, magnets in adjacent wells are in close spatial proximity. Under such circumstances, the magnetic field exerted on a given magnet by a magnet in an adjacent vessel may overlap or interfere with the external magnetic field which is applied to trigger the desired motion of each magnet. As a consequence, magnets in proximal wells may magnetically align and the movement supposed to be triggered by the external magnetic field may decrease or cease altogether.

To address inter alia this technical problem, the present invention provides, in a first aspect, a method of operating a device, said device comprising an array of vessels, one or more coils in sufficient proximity of at least two of said vessels such that an electric current flowing through said coil(s) exposes the interior of said vessels to a magnetic field, said at least two vessels each containing at least one first permanent magnet, and a power source connected to said coil(s), said method comprising: (a) delivering a fluctuating or oscillating electric current to said coil(s) to trigger movement of the first permanent magnets; and (b) intermittently applying a magnetic pulse sufficient to render first permanent magnets in nearby vessels not magnetically aligned with each other.

Said device, when operated in accordance with step (a), will generally provide for a fluctuating, oscillating or irregular motion of said permanent magnets inside said vessels. Depending on the contents of said vessel, said motion provides for mixing of ingredients, keeping particulate matter in suspension, lysing biological material such as cells or viruses, or fragmenting molecules such as biomolecules including proteins which may be, but do not have to be obtained by lysing cells or viruses. Accordingly, for most practical applications of the device, at least one of the vessel will contain a liquid or a sample, preferably a sample of biological origin.

Said array of vessels may be implemented as a microtiter plate; see further below. Vessels will have an opening which may be closed by a lid, said lid being optional. The vessels may have any shape, preferably they will be cylindrical, optionally tapered towards the bottom. In typical implementations, the majority of or all vessels of said array contain one or a plurality, preferably one of said first permanent magnets.

The coil(s) may be implemented as described below in relation to further aspects of the invention. An electric current flowing through a coil generates a magnetic field.

Said first permanent magnets are not particularly limited as regards material, shape or size.

Suitable magnets comprise or consist of ferro- and ferrimagnetic materials, in particular the following elements and their alloys: neodymium-iron, neodymium-iron-boron (e.g. Nd₂Fe₁₄B), cobalt, gadolinium, terbium, dysprosium, iron, nickel, iron oxides, manganese-bismuth, manganese-antimony, manganese-arsenic, yttrium-iron oxides, chromium oxides, europium oxides, and samarium-cobalt. Particularly preferred materials are neodymium-iron and samarium-cobalt.

In terms of size, the dimensions of said magnet are preferably such that the largest dimension of the magnet is smaller than the smallest dimension of the vessel, such as less than 0.9, 0.8, 0.7, 0.6, 0.5, 0.4, 0.3, 0.2, or 0.1 times the smallest dimension of said vessel. In case of vessels with a cylindrical or roughly cylindrical shape, said smallest dimension of said vessel is generally the circular diameter of the opening. Exemplary sizes (largest dimension) of magnets suitable for applications employing microtiter plates include sizes from 0.1 to 10 mm such as 0.1, 0.2, 0.3, 0.4, 0.5, 0.6, 0.7, 0.8, 0.9, 1, 2, 3, 4, 5, 6, 7, 8, 9, and 10 mm, preference being given to smaller values when using microtiter plates of higher density such as 384 and 1536 well plates. Such relative or absolute size allow or are chosen to allow a free motion of the magnet in three-dimensional space, which in turn provides best performance in terms of the envisaged applications of the device to be operated in accordance with the method of the first aspect.

In terms of shape of said magnet, there are no particular limitations, wherein preference is given to those shapes which do not negatively interfere with the free motion of the magnet. Exemplary shapes include sticks, bars, rods, rods with rounded ends, cubes, cuboids, prisms, spheres, elongate and oblate ellipsoids, disks, tetrahedrons, octahedrons, dodecahedrons, and icosahedrons.

The term “oscillating” designates a regular motion, whereas the term “fluctuating” is broader and embraces also irregular motion. There is no particular preference in that respect. In a preferred embodiment, amperage of said electric current as a function of time is (i) a rectangular function; (ii) a sinusoidal function; (iii) a triangular function; (iv) a sawtooth function; or (v) a combination or convolution of any one of (i) to (iv). Frequencies of fluctuations or oscillations of the current are not particularly limited, but may be between 50 and 1000 Hz.

Depending on the strength of the magnetic field generated by said first permanent magnets, and dependent on the degree of miniaturization (the spacing between the centres of adjacent wells decreases from 96 well plates to 384 well plates to 1536 well plates), interference between the magnetic fields generated by adjacent permanent magnets might not be avoidable. Such interference may lead to alignment of the magnets and the external magnetic field generated by the electric current and flowing through the coil(s) may fail to trigger the desired motion of the magnets.

By applying the pulse in accordance with (b), the alignment of magnets is broken and the motion of said magnets in response to the external field resumes. See FIG. 1 for a comparison of the undesirable aligned position (A) and the re-establishing free movement of the first permanent magnets upon applying the pulse (B).

As such, said magnetic pulse is distinct from the magnetic field generated by delivering a fluctuating or oscillating electric current to said coil(s), the latter serving to trigger continuous movement of the first permanent magnets. In particular, while the latter may fail to trigger movement of the first permanent magnets once they are in a magnetically aligned relative position, said magnetic pulse does not. To the contrary, said magnetic pulse is designed to break up said aligned position. To the effect, said magnetic pulse is inherently different, e.g. in terms of intensity, from said magnetic field generated by delivering a fluctuating or oscillating electric current to said coil(s). In particular, the magnetic field delivered by said pulse is stronger that the magnetic field generated by said coil(s) during step (a). Preferably, said magnetic field generated by said pulse is 1.1 to 1000 times stronger, such as 1.5, 2, 3, 4, 5, 6, 7, 8, 9, 10, 20, 50, 100, 200, or 500 times stronger that the magnetic field generated during step (a). To the extent magnetic fields are fluctuating, it preferred to use the mean magnetic field for such comparison. Preferably, said mean is an arithmetic mean over time. Alternatively, the maximum magnetic field applied in steps (a) and (b), respectively, may be used for said comparison.

The term “intermittently” refers to said pulse being applied (i) repeatedly in regular or irregular intervals, for example in response to measurements detailed further below or in pre-determined intervals, and/or (ii) for a period of time which is shorter than the period of time during which the device is operated in accordance with step (a). Preferred ratios of durations of step (a) to step (b) are 1.5 to 100, 2 to 50, 5 to 20 such as 10. Said ratios may be constant, i.e., they apply for each pulse, or may vary in which case the above numbers refer to time-averaged ratios. In addition, a fine-tuning of said ratio can be performed in order to optimally adjust to a given setup or application. The read-out of the sensors detailed further below may also be exploited for such purpose.

In a broad sense, a “pulse” in accordance with the invention is any change of the magnetic field sensed by said first permanent magnets which is sufficient to break up the magnetic alignment of said magnets. While conveniently and advantageously effected by changing the properties of the electric current used for step (a) (for details see below), said pulse may also be generated by any additional or further means capable of exposing said magnets to a magnetic field.

In a preferred embodiment, said magnetic pulse is effected by increasing said electric current for a duration of one or more of the fluctuations or oscillations of said electric current. This applies to all aspects of the invention employing or referring to a pulse, in particular to the third aspect disclosed further below.

In other words, said pulse may be oscillating or fluctuating, but does not have to be so. Said one or more fluctuations or oscillations may be between 1 and 1000 such as 1, 2, 3, 4, 5, 6, 7, 8, 9, 10, 20, 50 or 100 oscillations or fluctuations. A duration of one oscillation is generally sufficient. Tailoring the pulse to a given setup or application can be done without further ado.

Alternatively, the duration of said pulse may also be shorter than one oscillation, preferably between 0.001 and 0.99 times the duration of one oscillation such as 0.01, 0.1, 0.2, 0.3, 0.4, 0.5, 0.6, 0.7, 0.8 or 0.9 times the duration of one oscillation. Generally speaking, and in particular in cases of durations of less than one oscillation, the pulse may be non-oscillating and non-fluctuating and may have any profile such as a rectangular, triangular or sawtooth profile, wherein said profile may be applied once or more than one time, preferably 2 to 100 times such as 2, 3, 4, 5, 6, 7, 8, 9 or 10 times.

Said increase of the electric current may be between 1.1 and 100-fold such as 1.5-, 2-, 3-, 4-, 5-, 6-, 7-, 8-, 9-, or 10-fold.

Said increase may also be higher than 10-fold such as 20-fold, 50-fold or 100-fold, especially if said duration of said pulse is less than 1 oscillation.

Since preferably the pulse is generated by the same means, albeit more intense, as those used for step (a), the method of the first step may also be viewed as a continuous application of step (a) since the pulse in accordance with (b) triggers or re-establishes the motion intended to be triggered by step (a).

As detailed further below, a pulse may be applied also prior to effecting step (a) for the first time.

In a second aspect, the present invention provides a device comprising: (i) a removable array of vessels; (ii) at least two of said vessels each containing at least one first permanent magnet; (iii) one or more coil(s) in sufficient proximity of said at least two of said vessels such that an electric current flowing through said coil(s) exposes the interior of said vessels to a magnetic field; (iv) a power source connected to said coils; and (v) 1. means for measuring properties of the electric current flowing through said coils, said properties preferably being current and/or phase; 2. a plurality of sensors configured to measure a magnetic field in the proximity or inside the vessels, preferably for each of said vessel individually; and/or 3. means for measuring electromagnetic induction generated by the first permanent magnets in said coils, preferably at points in time where no electric current flows through said coils.

This device contains, in addition to the constituents of the device to be operated in accordance with the first aspect, means and/or sensors in accordance with item (v). As such, it is understood that said device is capable of performing the method of the first aspect.

A prototype device of the invention is shown in FIG. 2. A device of the invention including a shielding (see below for details) is shown in FIG. 4. Exemplary sensor read-outs are shown in FIG. 3.

In particular, said device is configured to deliver a fluctuating or oscillating electric current to said coils(s) to induce a magnetic field which triggers movement of the first permanent magnet(s); said device is configured to apply a magnetic pulse sufficient to release the first permanent magnets to the extent they are attached to a predetermined position inside each vessel and/or to release said first permanent magnets from a magnetically aligned relative position; and/or said device is configured to effect said magnetic pulse by increasing said electric current, preferably for a duration or one or more fluctuations or oscillations of said electric current.

While, as disclosed as a first aspect of the invention above, a device may successfully operated without any means or sensors in accordance with item (v), preference is given to a device in accordance with the second aspect, given that the latter device provides for a more targeted application of pulses. Said targeted application of pulses may be effected by a control element which controls the electric current. Said control element is preferably a constituent of said power source. Preferred means of feeding the read-out of the means or sensors of item (v) back into the power source are detailed further below in relation to the third aspect.

Means and sensors in accordance with (v) are preferably such that there is one per vessel. As regards (v) 1., this may be implemented by each vessel being surrounded by a coil, which is preferred, but not required (see further below). Having said that, in an alternative embodiment, one means or a sensor (v) may be used per group of adjacent vessels, such as one per two vessels or one per four vessels.

It is understood that means and sensors (v) are in sufficient proximity of the respective vessel where the field generated by a first magnet is to be measured.

Ensuring sufficient proximity of the means and sensors (v) to the vessels may be effected by incorporating said means and sensors into a plate comprised in said device, wherein said plate is configured to allow placement of the array of vessels on top thereof. Said plate may also comprise said one or more coils (iii). In the alternative, said plate does not comprise said one or more coils. Said one or more coils may then be comprised in a further plate or not part of any plate at all.

Sensors in accordance with (v) 2. may be implemented as Hall sensors or second coils. Hall sensors are known in the art and available from various manufacturers. They exploit the Hall effect to measure magnetic fields. A second coil measures the magnetic induction generated by the first permanent magnet.

In a preferred embodiment of the device of the second aspect, said sensors of (v) 2. are configured to or to be used to measure one or more of: intensity of said magnetic field, homogeneity of said magnetic field, presence or absence of the first permanent magnets, and movement of said first permanent magnets. It is an inherent property of Hall sensors to measure properties of a magnetic field. Since the first permanent magnets generate a magnetic field, the latter magnetic field is sensitive to position and motion of the first permanent magnets.

In a further preferred embodiment, said device further comprises one or both of (vi) means to determine the temperature of said coils; and (vii) means to keep the first permanent magnets in place.

Measuring the temperature of said coils is of interest in particular for those applications where vessels are used and/or samples are processed which are sensitive to elevated temperatures. As an alternative or in addition, the temperature inside the vessels may be measured and appropriate means may be comprised in the device of the second aspect.

Preferably, said means (vii) are selected from
a. one or more pieces of magnetic material;
b. one or more second permanent magnets;
C. one or more electromagnets;
wherein said means a., b., and c. are outside said vessels in the proximity of the first permanent magnets to keep said first permanent magnets at a predetermined position inside said vessels, wherein preferably the position of said pieces of a. and of said permanent magnets of b. is adjustable such that after adjustment a. and b. do not significantly interact with said first permanent magnets; and
d. non-magnetic means of attaching said first permanent magnets at a predetermined position inside each vessel.

Said electromagnets may be turned on and off depending on whether the first permanent magnets shall be kept in a predetermined position or allowed to move.

Said non-magnetic means are such that the attachment can be broken by a magnetic pulse. This can be achieved by attaching the magnet with glue, for example to the inside of the lid of the vessel (to the extent the vessel is equipped with a lid) or to the wall of the vessel. Alternatively or in addition, vessels may be equipped with a ridge which is designed to hold a magnet.

Said items a., b., and c. may also be used as means to generate the pulse in accordance with the method of the first aspect.

In a further preferred embodiment, (i) said array of vessels is a microtiter plate, preferably with 96, 384 or 1536 wells; (ii) the coil(s) are a single coil, preferably a Helmholtz coil, surrounding said array of vessels; or a plurality of coils, e.g. comprised in a printed circuit board; or a plurality of Helmholtz coils; wherein preferably said plurality of coils or said plurality of Helmholtz coils is such that each vessel of said array of vessels is surrounded by a coil; and/or (iii) said power source is configured for pulse width modulation.

Helmholtz coils are preferred because they deliver a homogeneous magnetic field.

A printed circuit board (PCB) with coils being printed thereon is advantageous in view of the ease of manufacture and the compact design. Such PCB is a preferred implementation of the above mentioned plate harboring said coils.

Pulse width modulation is an art-established means of controlling the time profile of an electric current. Preferred time profiles are disclosed above.

Preferably, said device furthermore comprises (viii) a housing 1. providing electromagnetic shielding; and/or 2. equipped with an opening or configured to be opened, to allow insertion and removal of said array of vessels.

In terms of geometry, said opening is preferably such that insertion and removal of said array of vessels occurs along the plane defined by said array. This facilitates handling by automated systems designed for high-throughput handling of samples.

In a third aspect, the present invention provides a method of operating a device in accordance with the second aspect, said method comprising (a) optionally applying a magnetic pulse sufficient to release the first permanent magnets to the extent they are attached to a predetermined position inside each vessel and/or to release said first permanent magnets from a magnetically aligned relative position; (b) delivering a fluctuating or oscillating electric current to said coil(s) to induce a magnetic field which triggers movement of the first permanent magnets; (c) analyzing the read-out generated by the means and/or sensors as defined in item (v) of said device; and (d) intermittently applying a magnetic pulse sufficient to render first permanent magnets in nearby vessels not magnetically aligned with each other when said analyzing of step (c) indicates that said first permanent magnets in nearby vessels are magnetically aligned.

In a preferred embodiment, said analyzing of (c) comprises comparing the read-out of said means and/or sensors as defined in item (v) of said device and obtained in the proximity of a first permanent magnet with the read-out at a distance from any first permanent magnet, said distance being sufficient for magnetic interference by any first permanent magnet to be negligible.

Said read-out at a distance provides the properties of the magnetic field generated by the coil(s) alone. Said read-out may be obtained from means or sensors which are placed in the proximity of a vessel, e.g. below a vessel which deliberately is left empty, i.e., contains no first permanent magnet.

In a further preferred embodiment, said method further comprises one or both of (a) modulating said electric current in response to the temperature determined by means (vi) of said device; and (b) adjusting the position of said pieces of a. or said second permanent magnets of b. such that they do not interact with said first permanent magnets, preferably when said electric current is being delivered.

If there is a risk of overheating vessels or samples contained therein, the amperage of the electric current may be lowered or set to zero.

Said adjusting serves to allow the first permanent magnets, initially fixed at a predetermined position, to begin to move. Adjusting will entail an increase of the spatial distance between said pieces or said second permanent magnets from the first permanent magnets.

In a fourth aspect, the present invention provides a computer program comprising instructions to cause the device of the second aspect to execute the steps of the method of the third aspect.

In a fifth aspect, the invention provides a computer-readable medium having stored thereon the computer program of the fourth aspect.

In a sixth aspect, the invention provides a kit of parts comprising: (a) a device comprising (i) one or more coils configured to receive an array of vessels; (ii) a power source connected to said coil(s); and (iii) 1. means for measuring properties of the electric current flowing through said coils, said properties preferably being current and/or phase; 2. a plurality of sensors configured to measure a magnetic field in the proximity or inside the vessels, preferably for each of said vessel individually; and/or 3. means for measuring electromagnetic induction generated by the first permanent magnets in said coils, preferably at points in time where no electric current flows through said coils;

and
(b) an array of vessels, at least two of said vessel each containing at least one first permanent magnet, wherein optionally each magnet is attached to a predetermined position inside each vessel and configured to be released by a magnetic pulse.

Preferred embodiments of the device of the second aspect apply mutatis mutandis to the kit of the sixth aspect.

### The Figures Show:

FIG. 1: A pulse in accordance with the invention breaks up the aligned position of the permanent magnets as shown in (A) such that motion resumes (B). “+” and “−” represent N and S pole of the magnets, respectively.

FIG. 2: Exemplary setup in accordance with the invention. A series of Hall sensors is attached to the bottom of a microtiter plate.

FIG. 3: Magnetic field as a function of time. (A) Baseline. (B) In Operation. Upper line: magnetic field generated by coils; lower line: sum of magnetic field of coils and of permanent magnets; middle line: difference (magnetic field of magnets only).

FIG. 4: External view of a device of the invention.

The Examples illustrate the invention.

### EXAMPLE 1

### Equipment and Protocol

A set of Hall sensors (Ratiometric Linear Hall Effect Magnetic Sensor DRV 5055A1-TI) has been attached to the bottom of a 96 well microtiter plate; see FIG. 2.

The majority of the wells of the microtiter plate each contain a permanent magnet (cylindrical 2×2 mm Nd magnet N48, magnetized along the cylinder axis).

A USB Digital Oscilloscope (IDSO1070A Hantek) is used for reading out the signals delivered by the sensors.

One of the Hall sensors is placed at a site where the magnetic field of permanent magnets in the wells is negligible, e.g. at the bottom of an empty well. This defines the baseline. When the device is in operation, the magnetic field generated by the coils is the baseline.

At least one Hall sensor is placed below a well containing a permanent magnet, wherein at least one of the wells with a Hall sensor below is surrounded by wells each of which contain a permanent magnet as well. This corresponds to the real world situation where the majority of wells will contain liquid and/or samples as well as a permanent magnet for sample preparation. This defines the measurement. The magnetic field is a sum of the magnetic field generated by the coils and the magnetic field generated by the permanent magnet.

### Measurements

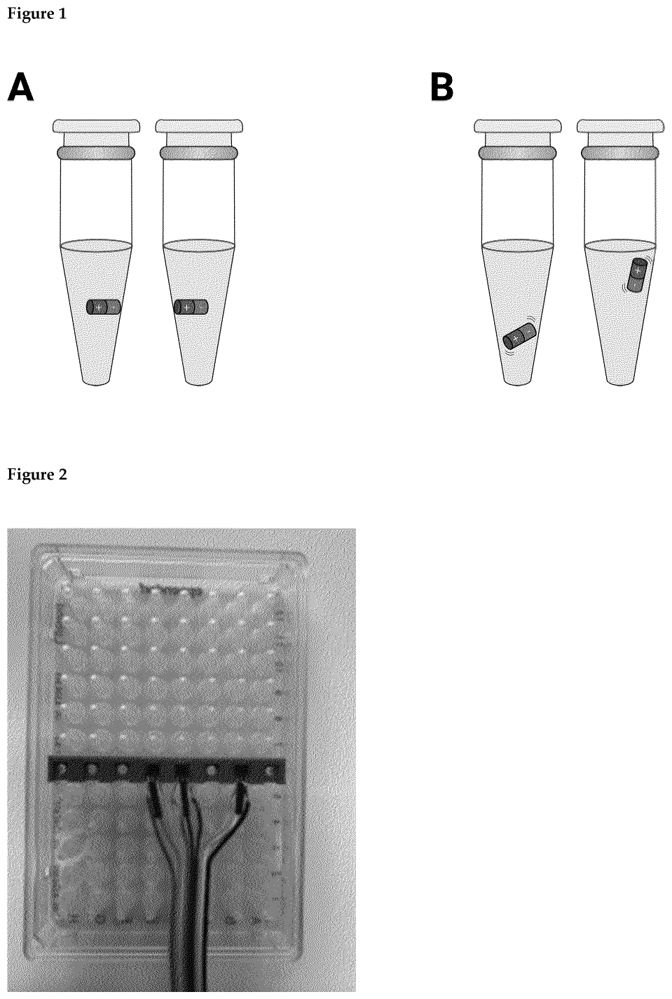

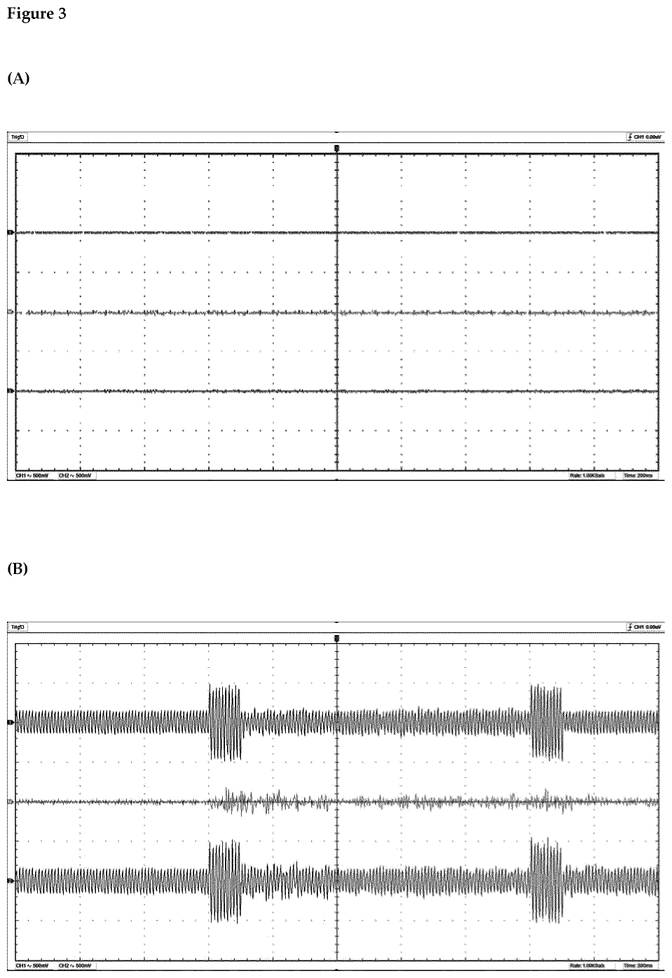

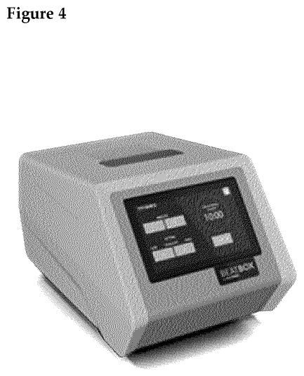

As shown in FIG. 3, the oscilloscope shows (i) the baseline, (ii) the measurement, and (iii) the difference measurement minus baseline. Said difference is the magnetic field which is generated by the permanent magnet only. This difference is sensitive to position and motion of the magnets. In case of an aligned position of the magnets (FIG. 1A), the Hall sensor does not detect a field originating from the magnets. In case of non-alignment or motion, the magnets deliver a field which is detectable by the sensors.

As can be seen in FIG. 3 (B), pulses successfully (i) initiate motion of the magnets when starting from aligned positions, and (ii) re-initiate motion if, after a period of free motions, the motion decreases and the magnets arrest in an aligned position. Intermittent application of pulses ensures constant motion of the magnets.

1. A method of operating a device,
said device comprising an array of vessels, one or more coils in sufficient proximity of at least two of said vessels such that an electric current flowing through said coil(s) exposes the interior of said vessels to a magnetic field, said at least two vessels each containing at least one first permanent magnet, and a power source connected to said coil(s),
said method comprising:
(a) delivering a fluctuating or oscillating electric current to said coil(s) to trigger movement of the first permanent magnets; and
(b) intermittently applying a magnetic pulse sufficient to render first permanent magnets in nearby vessels not magnetically aligned with each other.

2. The method of claim 1, wherein said magnetic pulse is effected by increasing said electric current for a duration of one or more of the fluctuations or oscillations of said electric current.

3. A device comprising:
(i) a removable array of vessels;
(ii) at least two of said vessels each containing at least one first permanent magnet;
(iii) one or more coil(s) in sufficient proximity of said at least two of said vessels such that an electric current flowing through said coil(s) exposes the interior of said vessels to a magnetic field;
(iv) a power source connected to said coils; and
(v) 1. means for measuring properties of the electric current flowing through said coils, said properties preferably being current and phase;
2. a plurality of sensors configured to measure a magnetic field in the proximity or inside the vessels, preferably for each of said vessel individually; and/or
3. means for measuring electromagnetic induction generated by the first permanent magnets in said coils, preferably at points in time where no electric current flows through said coils.

4. The device of claim 3, wherein said sensors of (v) 2. are configured to measure one or more of: intensity of said magnetic field, homogeneity of said magnetic field, presence or absence of the first permanent magnets, and movement of said first permanent magnets.

5. The device of claim 3 or 4, further comprising one or both of
(vi) means to determine the temperature of said coils; and
(vii) means to keep the first permanent magnets in place.

6. The device of claim 5, wherein said means (vii) are selected from
a. one or more pieces of magnetic material;
b. one or more second permanent magnets;
c. one or more electromagnets;
wherein said means a., b., and c. are outside said vessels in the proximity of the first permanent magnets to keep said first permanent magnets at a predetermined position inside said vessels, wherein preferably the position of said pieces of a. and of said permanent magnets of b. is adjustable such that after adjustment a. and b. do not significantly interact with said first permanent magnets; and
d. non-magnetic means of attaching said first permanent magnets at a predetermined position inside each vessel.

7. The device of any one of claims 3 to 6, wherein
(i) said array of vessels is a microtiter plate with 96, 384 or 1536 wells;
(ii) the coil(s) are a single coil, preferably a Helmholtz coil, surrounding said array of vessels; or a plurality of coils, e.g. comprised in a printed circuit board; or a plurality of Helmholtz coils; wherein preferably said plurality of coils or said plurality of Helmholtz coils is such that each vessel of said array of vessels is surrounded by a coil; and/or
(iii) said power source is configured for pulse width modulation.

8. The device of any one of claims 3 to 7, wherein said device furthermore comprises (viii) a housing
1. providing electromagnetic shielding; and/or
2. equipped with an opening or configured to be opened, to allow insertion and removal of said array of vessels.

9. A method of operating a device as defined in any of claims 3 to 8, said method comprising
(a) optionally applying a magnetic pulse sufficient to release the first permanent magnets to the extent they are attached to a predetermined position inside each vessel and/or to release said first permanent magnets from a magnetically aligned relative position;
(b) delivering a fluctuating or oscillating electric current to said coil(s) to induce a magnetic field which triggers movement of the first permanent magnets;
(c) analyzing the read-out generated by the means and/or sensors as defined in claim 3(v); and
(d) intermittently applying a magnetic pulse sufficient to render first permanent magnets in nearby vessels not magnetically aligned with each other when said analyzing of step (c) indicates that said first permanent magnets in nearby vessels are magnetically aligned.

10. The method of claim 9, wherein said analyzing of (c) comprises comparing the read-out of said means and/or sensors as defined in claim 3(v) obtained in the proximity of a first permanent magnet with the read-out at a distance from any first permanent magnet, said distance being sufficient for magnetic interference by any first permanent magnet to be negligible.

11. The method of claim 9 or 10, said method further comprising one or both of
(e) modulating said electric current in response to the temperature determined by means (vi) of said device; and
(f) adjusting the position of said pieces of claim 6 a. or said second permanent magnets of claim 6 b. such that they do not interact with said first permanent magnets, preferably when said electric current is being delivered.

12. A computer program comprising instructions to cause the device of any one of claims 3 to 8 to execute the steps of the method of any one of claims 9 to 11.

13. A computer-readable medium having stored thereon the computer program of claim 12.

14. A kit of parts comprising:
(a) a device comprising
(i) one or more coils configured to receive an array of vessels;
(ii) a power source connected to said coil(s); and
(iii) 1. means for measuring properties of the electric current flowing through said coils, said properties preferably being current and phase;
2. a plurality of sensors configured to measure a magnetic field in the proximity or inside the vessels, preferably for each of said vessel individually; and/or
3. means for measuring electromagnetic induction generated by the first permanent magnets in said coils, preferably at points in time where no electric current flows through said coils;
and
(b) an array of vessels, at least two of said vessel each containing at least one first permanent magnet, wherein optionally each magnet is attached to a predetermined position inside each vessel and configured to be released by a magnetic pulse.
